(19) United States
(12) Patent Application Publication
(10) Pub. No.: US 2012/0256075 A1
(43) Pub. Date: Oct. 11, 2012

(54) METHOD OF PRODUCING SPLIT OUTER SHELL CRADLE MOUNT WITH RATE PLATES

(75) Inventors: Travis Jon Grassmid, Zeeland, MI (US); Troy Molesworth, South Haven, MI (US)

(73) Assignee: Trelleborg Automotive USA, Inc., South Haven, MI (US)

(21) Appl. No.: 13/443,954

(22) Filed: Apr. 11, 2012

Related U.S. Application Data
(60) Provisional application No. 61/473,927, filed on Apr. 11, 2011.

(51) Int. Cl. F16M 13/02; B29C 45/14

(52) U.S. Cl. 248/674; 425/123; 264/261

(57) ABSTRACT

A cradle mount assembly for use in vehicle is provided including at least two inserts having at least two rate plates connected to each respective insert. The rate plates connected to the inserts by means of a connection or structural portion. A mold provided to mold plastic, polymer or other suitable material around the at least one insert and the at least one rate plate. The mold having structure capable of accepting the connection or structural portion connecting the at least one rate plate to the at least one insert. A method is further provided for the molding process including the steps of connecting the at least one insert and the at least one rate plate to the mold by means of the connection or structural portion. The mold is then formed around the at least one insert and the at least one rate plate.

### CROSS-REFERENCE TO RELATED APPLICATIONS

This application claims priority of U.S. Provisional Patent Application 61/473,927 filed Apr. 11, 2011, the contents of which are incorporated herein by reference.

### FIELD OF THE INVENTION

The present invention relates generally to apparatus and method of producing cradle mounts. In particular, the present invention relates to a method of producing split outer shell cradle mounts having rate plates and the corresponding apparatus.

### BACKGROUND OF THE INVENTION

Cradle mounts are frequently known and used to securely mount motors within the engine cavity of a vehicle. Split shell cradle mount designs in the current market utilize steel or aluminum outer clamshell and steel rate plate building inserts. These designs have inherent production problems due to the small size of the five inserts required to be placed precisely into each rubber mold cavity. These designs require cavity holding features, such as chaplet pins, which have a large free area around the insert. This free area allows for the operator to place the insert into the mold. This free area also creates extra space in the cavity and thus allows rubber to leak around the inserts during the injection process. If the rubber mold is built so that the inserts fit securely and tightly into the mold, the mold operator will struggle to keep up with the mold cycle.

A second existing technology is the use of individual plastic rate plates. The use of these pieces is problematic in that said plastic pieces do not maintain their shape and location in the mold due to the internal mold pressure and also because of heat.

A third existing problem with this technology is preventing rubber from being on the outside of the clamshell outer metals. Because there exists a need to use two separate metals, and the separation is a vertical separation feature in the mold, it is currently difficult to pinch the metals and prevent rubber from flowing to the area outside of the clamshell outer metals.

Accordingly, there exists a need to develop a cradle mount overcoming the inadequacies of the present technology.

### SUMMARY OF THE INVENTION

A cradle mount assembly for use in vehicle is provided. The assembly includes at least two inserts having at least two rate plates connected to each respective insert. The rate plates connected to the inserts by means of a connection or structural portion. A mold provided to mold plastic, polymer or other suitable material around the at least one insert and the at least one rate plate. The mold having structure and cavities capable of accepting the connection or structural portion connecting the at least one rate plate to the at least one insert. A method is further provided for the molding process including the steps of connecting the at least one insert and the at least one rate plate to the mold by means of the connection or structural portion. The mold is then formed around the at least one insert and the at least one rate plate.

### BRIEF DESCRIPTION OF THE DRAWINGS

FIG. 1 is a perspective view of the prior art (clam shell outer);

FIG. 2 is a perspective view of the prior art (rate plate);

FIG. 3 is a top view of the prior art (molded assembly);

FIG. 4 is a top view of the present embodiment of the improved cradle mount molded assembly before removable tabs are removed;

FIG. 5 is a perspective view of the plastic insert of the present invention;

FIG. 6 is a cross sectional perspective view of the bottom cavity of the rubber mold;

FIG. 7 depicts the tapered cylinders molded onto the outside edge of the plastic rate plates;

FIG. 8 shows a perspective environmental view of the cradle mount of the present invention; and

FIG. 9 depicts the method of the present invention.

### DETAILED DESCRIPTION OF THE INVENTION

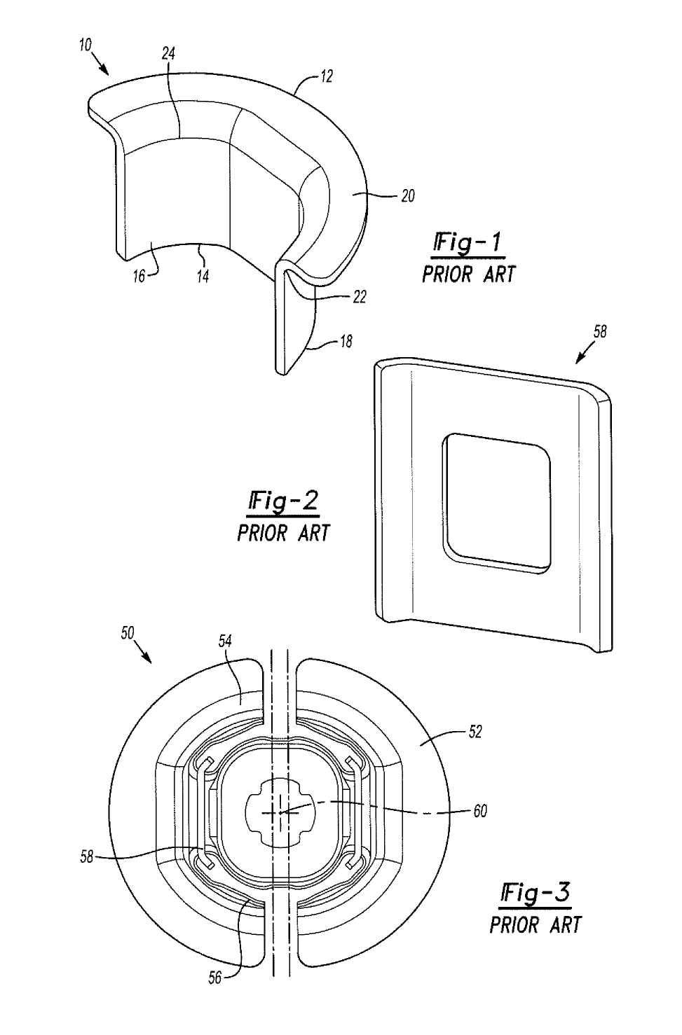

The present invention generally improves the molding or vulcanization operation of a split shell cradle mount design and further allows for the use of plastic for the rate building inserts (rate plates). Tapered cylindrical structures which correspond to holding features in the mold allow for a gripping action to hold the rate plate in place when the mold is injected with hot liquid rubber prior to vulcanization. The prior art as shown in FIGS. 1, 2 and 3 depicts previous split outer shell cradle mount designs utilizing expensive metal and at least four parts. A clam shell 10 includes an upper surface 14 and a lower surface 12 and is generally made of a metal. In the prior art, two clam shells 10 are used per mount. The clam shell 10 further includes an inner surface 16 and planar surface 20. The metal clam shell 10 further includes an outer surface 18 having curvature structure 22, 24. The prior art full molded assembly 50, as shown in FIG. 3, includes at least two outer clam shells 10 used per mount. Rubber 60 is used to connect all assembly pieces and inserts together to form the entire molded assembly 50. FIG. 2 depicts the prior art rate plate 58 in independent form. The prior art rate plate 58 is also shown in FIG. 3 is fully assembled into the entire molded assembly 50.

FIG. 5 shows a one piece plastic rate plate/clam shell insert 104. The insert 104 essentially combines 2 of the prior art rate plates 58 and two of the clam shells 10 into a one-piece construction further allowing for ease of assembly and manufacturing. Furthermore, the insert 104 may alternatively be composed of a recyclable material allowing for increased ease of recycling over the traditional metal components.

The insert 104 includes a lower surface 105 adapted to fit securely in the bottom surface 205 of the mold 200 (as shown in FIG. 6). The insert 104 is a one piece construction (versus at least two in previous technology) allowing for simplified and faster production versus individual pieces. The one piece construction of the insert 104 allows the production facility to cycle the molds faster, with less change in mold temperature. Said procedure will decrease the cost of molding/vulcanization, and also decrease the part-to-part variation. The one piece plastic insert 104 also allows for improved part condition at mold removal. The plastic residual from the plastic insert 104 will choke off the rubber better than steel or aluminum allows for and therefore plastic or rubber will not flow to the outside surface of the clamshells.

Furthermore, the plastic inserts 104 are lighter weight than aluminum and/or steel inserts. Lighter parts are much preferred in the automotive industry, due to the negative effect of weight on gas efficiency. Also, the use of plastic insert 104 allows for a colored plastic to be used as the visual color feature thereby further improving assembly productivity.

The insert 104 further includes various structural features allowing the insert 104 to be secured within the mold during the injection process. Rate plate 120 extends between two distinct points on the inner surface 118 of the insert 104. Rate plate 120 includes a planar surface 124 and a lower surface 126. The rate plate 120 further connects to the inner surface 118 of the insert 104 by connectors or structural supports 110, 112. The mold 200 allows for accommodation of the structural features 110, 112 in the holding means 210. Furthermore, rate plate 120 further includes curved tapered cylinders 140.

The mold 200 accommodates the tapered cylinders 140 at accepting means 240. The tapered cylinders 140 and accommodating structure 240 of the mold 200 prevent any movement of the rate plate 120 within the mold 200 during the injection process. The cavities or connectors or structural supports 110, 112 also prevent any movement of the plastic insert 104 within the mold 200 during the injection process. Furthermore, connection member 116 connects the two clamshell type structures of the insert 104 together to form a one piece construction. After vulcanization, the connection members 116 and the structural support 110 are removed. The connection members 116 and the structural supports 110 provide increased stability and support of the plastic or rubber components during the vulcanization process.

The plastic insert 104 fits securely within the mold 200 during the injection molding process or vulcanization process. The lower surface 105 of the insert 104 fits within the lower surface 205 of the mold 200 during the vulcanization process. A lower surface 126 of the rate plate 122 rests on a lower surface 226 of the mold 200.

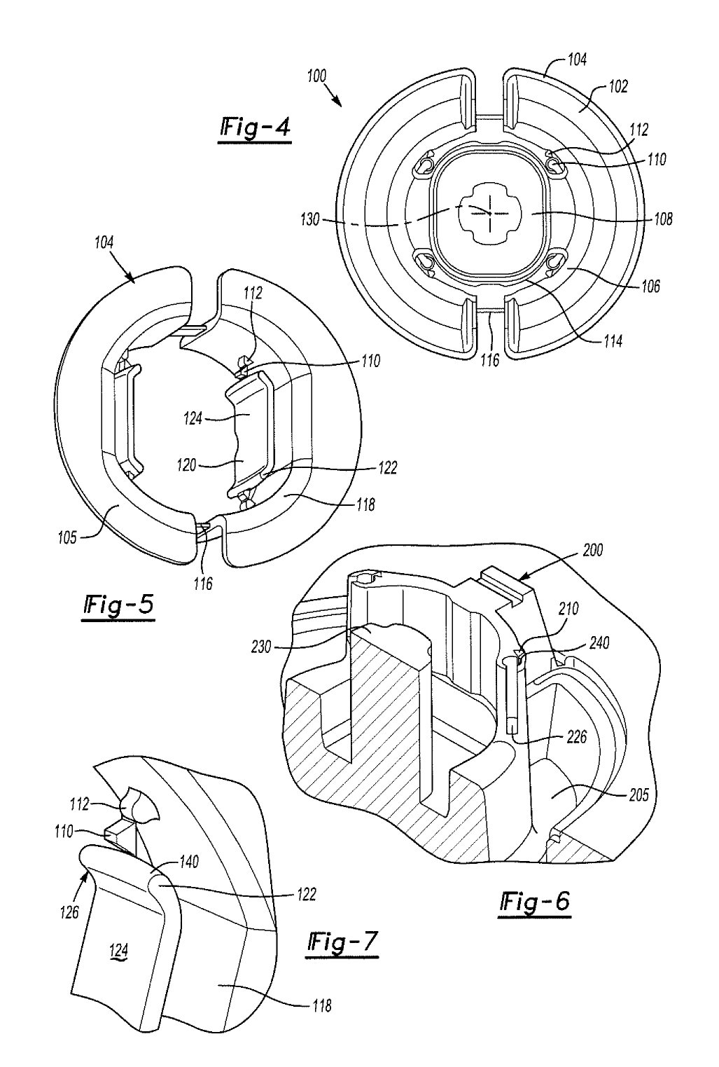

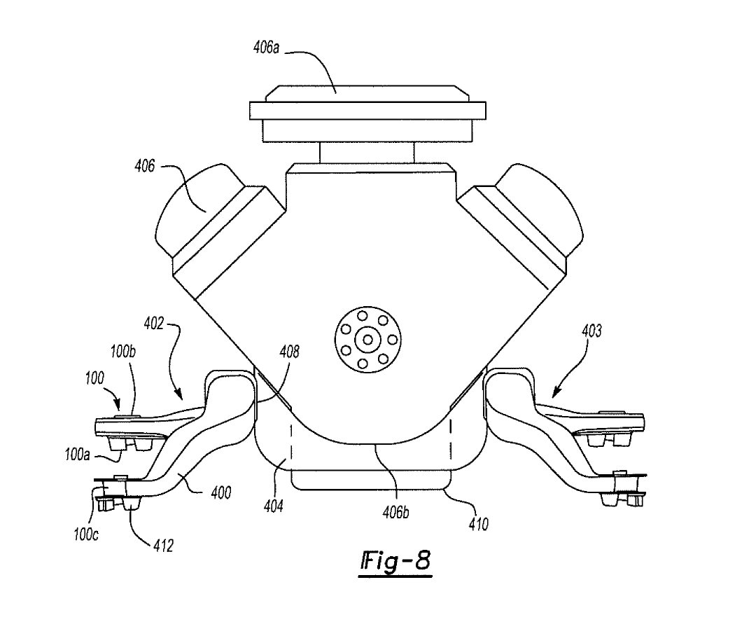

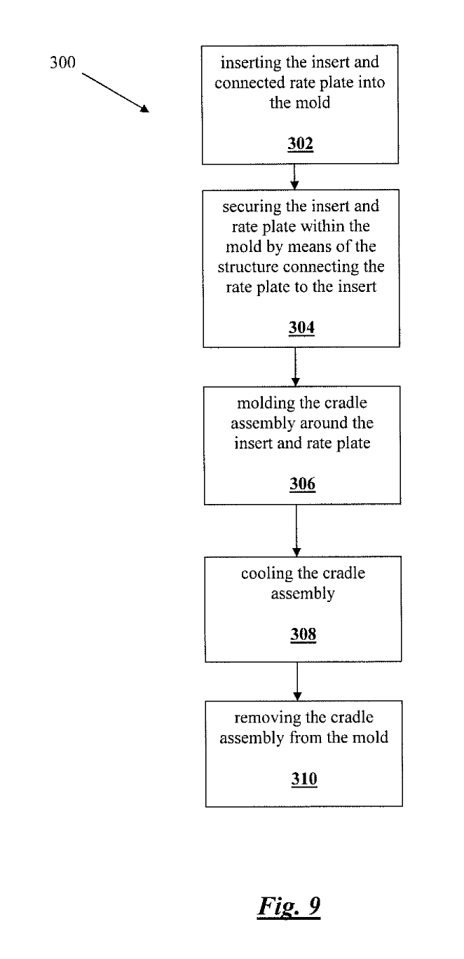

FIG. 4 shows the insert 104 and the rubber 102 after the vulcanization process is complete. A cradle mount 100 when fully assembled includes the molded injected rubber 102 and the plastic insert 104. A center aperture 130 is provided to fit on the projection 230 of the mold assembly. For an environmental perspective, the aperture 130 is further used when the cradle mount assembly 100 is used to mount the body of a vehicle. The body sits on the mount and utilizes aperture 130. An additional jounce bumper may be required to securely mount the body to the main vehicle frame.

FIG. 8 illustrates a perspective view of the environment of the cradle mount 100. The cradle mount 100 having the injected molded rubber 102 and the plastic insert 104 are attached to an arm 400, or set of arms 402, 403. The arms 400, 402, 403 are mounted to a cradle 404. The arms 400 are generally hollow having a generally rectangular or square cross section. The arms 400 are made of a metal (such as aluminum, steel or various other metals and/or alloys) or plastic, polymer or polymer like material. The cradle 404 is generally rectangular or square in shape. The cradle 404 is designed with generally hollow arms having generally rectangular or square cross sections. The cradle 404 is operable to hold the engine or motor 406 within the vehicle. The engine 406 attaches to the cradle 404. The cradle mounts 100 then attach to the vehicle frame. The engine 406 includes an upper portion 406a and a bottom portion 406b. The bottom portion 406b mounts near and within the cradle 404. Support 410 of the cradle 404 further supports the engine 406.

The arms 400 include the cradle mounts 100. In the present embodiment there are two sets of arms 402, 402 and 4 total arms each having a cradle mount 100. Each of the arms 400 include a sleeve to accept the cradle mount therein. The arms 402, 403 connect to the cradle 404 as shown at reference numeral 408. The arms 402, 403 connect to the cradle 404 by means of a bolt or other suitable attachment means.

FIG. 9 shows a method 300 for manufacturing the cradle mount assembly. The method 300 includes utilizing an insert having a connected rate plate and a mold having corresponding structure to secure the insert and rate plate. The method 300 comprising the steps of molding a one piece insert (discussed above) having at least one rate plate and at least one insert, inserting 302 the insert and connected rate plate into the mold, securing 304 the insert and rate plate within the mold by means of the structure connecting the rate plate to the insert, molding 306 the cradle assembly around the insert and rate plate, cooling 308 the cradle assembly and removing 310 the cradle assembly from the mold. The at least one rate plate and the at least one insert is securely mounted within the mold by the connection or structural portion 110, 112. The user then pours liquid polymer or plastic (or metal or other suitable material) into the mold surrounding the at least one insert and the at least one rate plate.

The invention is not restricted to the illustrative examples and embodiments described above. The embodiments are not intended as limitations on the scope of the invention. Methods, apparatus, compositions, and the like are described herein and are exemplary and not intended as limitations on the scope of the invention. Changes therein and other uses will occur to those skilled in the art.

1. A cradle mount assembly for use in a vehicle, the cradle mount assembly used for mounting a vehicle engine, the cradle mount comprising:
at least one insert, the at least one insert having connecting portions;
at least one rate plate, the rate plate received between the connecting portions of the insert; and
a plastic disposed around the at least one insert and around the at least one rate plate.

2. The cradle mount assembly of claim 1 wherein the at least one rate plate includes at least one tapered cylinder.

3. The cradle mount assembly of claim 2 wherein the tapered cylinder of the rate plate is connected to the rate plate.

4. The cradle mount assembly of claim 1 wherein the connector portion is triangular in shape.

5. The cradle mount assembly of claim 1 wherein two inserts having two connected rate plates are connect to one another.

6. The cradle mount assembly of claim 5 wherein the two inserts are connected to one another by means of a connector portion.

7. The cradle mount assembly of claim 1 wherein the inserts are curved into a semi-circle configuration.

8. The cradle mount assembly of claim 7 wherein two connected inserts generally form a circle.

9. The cradle mount assembly of claim 1 wherein the inserts include an upper planar surface.

10. A mold for forming a cradle mount assembly, the mold used in connection with an insert and rate plate assembly having connecting portions, the mold comprising:
a main cavity;
at least one secondary cavity for receiving the connecting portions of the insert and rate plate assembly, the at least one secondary cavity having corresponding geometry as compared to the connecting portions, the at least one secondary cavity disposed within the main cavity.

11. The mold according to claim 10 wherein the at least one secondary cavity has a triangular cross section.

12. The mold according to claim 10 wherein the at least one cavity has a circular cross section.

13. A method for manufacturing a cradle mount assembly, the method utilizing an insert having a connected rate plate and a mold having corresponding structure to secure the insert and rate plate, the method comprising the steps of:
molding a one piece insert having at least one rate plate and at least one insert;
inserting the insert and connected rate plate into the mold;
securing the insert and rate plate within the mold by means of the structure connecting the rate plate to the insert;
molding a plastic within a mold to create the cradle assembly around the insert and rate plate;
cooling the cradle assembly; and
removing the cradle assembly from the mold.

14. The method according to claim 13 further including the step of pouring liquid plastic or polymer into the mold around the at least one insert and the at least one rate plate.

15. The method according to claim 13 further including the step of securing the connection portion attaching the rate plate to the insert to corresponding structure on the mold before the molding process.
